(19) United States
(12) Patent Application Publication
(10) Pub. No.: US 2022/0258831 A1
(43) Pub. Date: Aug. 18, 2022

(54) BRAKE UNIT FOR A VEHICLE, BRAKE DEVICE COMPRISING THE BRAKE UNIT AND VEHICLE COMPRISING THE BRAKE UNIT AND/OR THE BRAKE DEVICE

(71) Applicant: Schaeffler Technologies AG & Co. KG, Herzogenaurach (DE)

(72) Inventors: Stephane Rocquet, Sandillon (FR); Simon Ortmann, Baden-Baden (DE); Alexis Galant, Saran (FR); Julien Durr, Fleury les aubrais (FR)

(73) Assignee: Schaeffler Technologies AG & Co. KG, Herzogenaurach (DE)

(21) Appl. No.: 17/618,026

(22) PCT Filed: May 14, 2020
(86) PCT No.: PCT/DE2020/100415

§ 371 Date: Dec. 10, 2021

(30) Foreign Application Priority Data
Jun. 18, 2019 (DE) 10 2019 116 428.1

(51) Int. Cl. B62L 3/02; F16D 55/02; B62L 1/00; F16D 65/00

(52) U.S. Cl. CPC B62L 3/023; F16D 55/02; F16D 2121/04; F16D 65/0087; B62L 1/005

(57) ABSTRACT

A brake unit for a vehicle is disclosed, including a housing, a hydraulic unit, a braking element unit, wherein the braking element unit forms or supports a braking partner in a braking device for the vehicle. The housing, the hydraulic unit and/or the braking element unit define a main axis, wherein the hydraulic unit moves the braking element unit in an axial direction relative to the housing, in order to generate a braking force, and having a guide unit. The guide unit guides the braking element unit in the radial direction during the axial movement, wherein the guide unit has a master guide and an auxiliary guide, wherein the master guide and the auxiliary guide are arranged eccentrically.

### CROSS-REFERENCE TO RELATED APPLICATIONS

This application is the U.S. National Phase of PCT Appln. No. PCT/DE2020/100415 filed May 14, 2020, which claims priority to DE 102019116428.1 filed Jun. 18, 2019, the entire disclosures of which are incorporated by reference herein.

### TECHNICAL FIELD

The disclosure relates to a brake unit for a vehicle having the features disclosed herein. The disclosure further relates to a braking device comprising the brake unit, and to the vehicle comprising the brake unit and/or comprising the braking device.

### BACKGROUND

In human-powered vehicles, e.g., bicycles etc., it is customary to use drum brakes, disc brakes or shoe brakes. Each of the braking systems has different advantages in terms of braking effect, system costs, ease of maintenance, etc.

For example, publication DE 200 16 878 U1 describes a pedal scooter with a braking device in the form of a hydraulically activated disc brake. The braking device has a brake disc connected to a wheel in a non-rotatable manner and a brake caliper fixed to the frame of the pedal scooter, wherein the brake caliper contains brake pads acting on the brake disc.

### SUMMARY

It is the object of the present disclosure to propose a brake unit with a modified structure for a vehicle. This object is achieved by a brake unit, a braking device, and a vehicle with the features described herein. Preferred or advantageous embodiments of the disclosure are disclosed in the claims, the following description, and the attached figures.

The disclosure relates to a brake unit which is suitable and/or designed for a vehicle. In particular, the vehicle is designed as a single or multi-track vehicle. Preferably, the vehicle is designed as an electrically powered vehicle. For example, the vehicle is a small electric vehicle, whereby “small electric vehicle” means vehicles without a seat or self-balancing vehicles with or without a seat.

Preferably, the vehicle is designed as a small or micro vehicle or as an electric vehicle. Preferably, the vehicle has at least one wheel. With only one wheel, the vehicle can be configured as an electric unicycle, e.g., as a so-called monowheel or solowheel. With two or more wheels, the vehicle is preferably designed as a scooter, in particular as an electric motorcycle, as an electric motor scooter, as an electric pedal scooter, electric scooter, e.g., e-scooter, as a Segway, hoverboard, kickboard, skateboard, longboard or the like. Alternatively, the vehicle can be designed as a bicycle, in particular as an electric bicycle, for example as a pedelec or as an e-bike. The vehicle can alternatively be designed as a multi-track bicycle, in particular with three or more wheels. For example, the vehicle may be a transport or cargo bike, in particular a motorized or electrically powered transport or cargo bike, more specifically a three-wheeled or four-wheeled pedelec or a rickshaw, in particular with or without a roof, or a cabin scooter.

The vehicle can include one or more of the brake units. The brake unit has a housing, wherein the housing is arranged and/or is arrangeable on the vehicle in a stationary and/or non-rotatable manner. Preferably, the housing is arranged coaxially with a wheel axle of the vehicle. In particular, the wheel axle penetrates the housing. For this purpose, the housing has, for example, a through opening for receiving the wheel axle.

The brake unit has a hydraulic unit for generating a hydraulic force. Further, the brake unit has a braking element unit, the braking element unit forming or supporting a braking partner in a braking device for the vehicle. In particular, the braking element unit forms the stationary braking partner, with a rotating braking partner being connected to a wheel of the vehicle in a non-rotatable manner.

The brake unit has a main axis, the main axis being understood as a constructive and/or imaginary auxiliary axis. The main axis can be defined, for example, by the housing, in particular by the through opening or the wheel axle. Alternatively, the main axis can be defined by the hydraulic unit, in particular coaxial to a piston and/or to a cylinder. Alternatively or in addition, the main axis can be defined by the braking element unit.

It is provided that the hydraulic unit moves the braking element unit relative to the housing in an axial direction to generate a braking force. In particular, the braking force is transmitted from the braking element unit as stationary braking partner to the rotating braking partner. For example, the cylinder of the hydraulic unit can be operatively connected to the housing and the piston of the hydraulic unit can be operatively connected to the braking element unit. Particularly preferably, the cylinder is connected to the housing and the piston is connected to the brake body device in a fixed or form-fitting manner.

The brake unit has a guide unit which, when the braking element unit moves axially relative to the housing, guides the braking element unit in the radial direction, in particular to the main axis. This, for example, prevents tilting between the braking element unit and the housing.

In the context of the disclosure, it is proposed that the guide unit has a master guide and an auxiliary guide. Thus, the guide unit has at least or exactly two guides. It is provided that the master guide and the auxiliary guide are arranged eccentrically to the main axis. In particular, they are not placed coaxially, but offset from the main axis.

Here, it is a consideration of the disclosure that when the braking force is transmitted from the stationary braking partner to the rotating braking partner in the stationary braking partner, torques about the main axis are introduced into the braking element unit in addition to axial forces, in particular in addition to braking forces or corresponding counterforces. In order to avoid tilting or twisting of the braking element unit relative to the housing, it is proposed to equip the guide unit with at least or exactly two separate individual guides.

The disclosure can be used particularly advantageously if the braking element unit has a braking surface, the braking surface being formed circumferentially, in particular uninterruptedly or largely uninterruptedly, with respect to the main axis. In particular, the braking surface is designed as a continuous circular ring. As is common, the braking surface may be perforated by ventilation holes, mounting holes or the like. Alternatively or in addition, the hydraulic unit may have an annular space and an annular piston, the annular piston being arranged in the annular space. The hydraulic fluid for actuating the annular piston is arranged in the annular space. The annular space and the annular piston are formed circumferentially to the main axis. Both alternatives reflect the fact that the brake unit is not designed in a segment-like manner with regard to the braking surface, but extends over 360° around the main axis. The torques introduced by this constructive embodiment can be diverted particularly effectively by the guide device according to the disclosure.

In a preferred constructive embodiment of the disclosure, the master guide has a first radial clearance and the auxiliary guide has a second radial clearance. The radial clearance can be measured locally in the master guide and in the auxiliary guide. If the master guide and/or the auxiliary guide are designed to be rotationally symmetrical, the radial clearance can be measured locally in every direction with respect to the master guide or to the auxiliary guide. Alternatively or in addition, the radial clearance can be measured in the direction of rotation around the main axis. Thus, the torque in the direction of rotation is absorbed primarily by the master guide and secondarily by the auxiliary guide. This results in the torque being safely diverted. On the other hand, the different radial clearance ensures that there is no over-definition of the brake unit in the direction of rotation about the main axis, thus preventing jamming of the braking element unit even at different temperatures etc.

In a preferred constructive embodiment, the master guide has a first axle section, which is arranged on the braking element unit and, in particular, forms a component of the braking element unit. Furthermore, the master guide has a first guide section which is arranged on the housing and, in particular, forms a component of the housing. The first axle section is arranged coaxially in the first guide section and is guided by it. Alternatively or in addition, the auxiliary guide has a second axle section which is arranged on the braking element unit and, in particular, forms a component of the braking element unit. Furthermore, the auxiliary guide has a second guide section which is arranged on the housing and, in particular, forms a component of the housing. The second axle section is arranged coaxially in the second guide section and is guided by it. The second radial clearance is measured between the second axle section and the second guide section, preferably in the direction of rotation about the main axis or alternatively about its own central axis. Preferably, the axle sections and/or the guide sections in the guide area are designed to be rotationally symmetrical.

It can be provided that the axle sections each have a guide surface, thus a first and a second guide surface, for contact with the guide sections. This configuration has the advantage that very few components or parts are used. On the other hand, the axle sections or the guide sections must be made of a corresponding material suitable for the function. Alternatively, it is particularly preferred that a first guide sleeve is placed on the first axle section, which provides the first guide surface. Alternatively or in addition, the second axle section has a second guide sleeve, which provides the second guide surface. In particular, the first and/or the second guide sleeve is designed as a straight hollow cylinder. The use of a guide sleeve can provide a hard and thus low-wear guide surface, but the axle sections of the braking element unit can be formed from any material.

The first radial clearance is measured between the first guide surface, in particular the first axle section or (if present) the first guide sleeve, and the first guide section, preferably in the direction of rotation about the main axis or alternatively about its own central axis. The second radial clearance is measured between the second guide surface, in particular the second axle section or (if present) the second guide sleeve, and the second guide section, preferably in the direction of rotation about the main axis or alternatively about its own central axis.

In a preferred further embodiment of the disclosure, the housing has a housing base body. The housing base body can be manufactured, for example, by aluminum die-casting. It is particularly preferred that the first and/or the second guide section is integrally formed by the housing base body. This means that the guide sections are formed by a section of die-cast aluminum and can thus be manufactured at low cost. Alternatively or in addition, the braking element unit has a brake base body. The brake base body can be manufactured, for example, by aluminum die-casting. It is particularly preferred that the first and/or the second axle section is integrally formed by the brake base body. This means that the axle sections are formed by a section of die-cast aluminum and can thus be manufactured at low cost.

In one possible constructive embodiment, the braking element unit has a force distribution plate. The force distribution plate is implemented in particular as a sheet metal plate made of metal. The force distribution plate is operatively connected to the hydraulic unit. Particularly preferably, the force distribution plate has a contact surface for the annular piston or for an adapter piece which is supported against the annular piston. The force distribution plate is connected to the braking element unit via the first, the second and also via at least or exactly one third axle section. Preferably, the force distribution plate is connected to the brake base body via the at least or exactly three axle sections.

In a preferred constructive embodiment, it can be provided that the three axle sections are regularly distributed in the direction of rotation in order to introduce the braking force as uniformly as possible into the braking element unit. The third axle section is guided in the radial direction and/or in the direction of rotation with an even greater radial clearance than the first and/or second radial clearance or not at all.

In a preferred further embodiment of the disclosure, the brake unit has a return unit for returning the braking element unit. The return unit has a first return spring, a second return spring and a third return spring. The first return spring is assigned to the master guide, the second return spring to the auxiliary guide, and the third return spring to the third axle section. In this way, the return force is also introduced evenly after the braking process. On one side, the return springs and/or the return unit are supported on the housing and, on the other side, preferably on the brake base body.

Another object of the disclosure relates to a braking device for a vehicle, wherein the braking device has the brake unit as previously described. Particularly preferably, the braking element unit has a brake disc, wherein the brake disc is made of metal. Furthermore, the braking device has a brake pad, wherein the brake pad is connected to the wheel of the vehicle in a non-rotatable manner. Preferably, the brake pad is also designed to be circular in shape.

Another object of the disclosure relates to a vehicle with the brake unit and/or with the braking device as previously described. It is intended that the vehicle is an electric motorcycle or an electric scooter. It is particularly preferred that the vehicle has an electric motor, wherein the electric motor is arranged in the wheel, forms the wheel and/or is designed as a hub motor.

### BRIEF DESCRIPTION OF THE DRAWINGS

Further features, advantages and effects of the disclosure are set out in the following description of the preferred embodiments of the disclosure. In the figures:

FIG. 1 shows a three-dimensional representation of a vehicle with a brake unit as an embodiment of the disclosure;

FIG. 2 shows a schematic sectional view of the brake unit of FIG. 1 as a further embodiment of the disclosure.

FIG. 3 shows a three-dimensional, schematic axial representation of the brake unit from FIG. 1.

### DETAILED DESCRIPTION

Parts that correspond to each other or are identical are marked with the same reference marks in the illustrations.

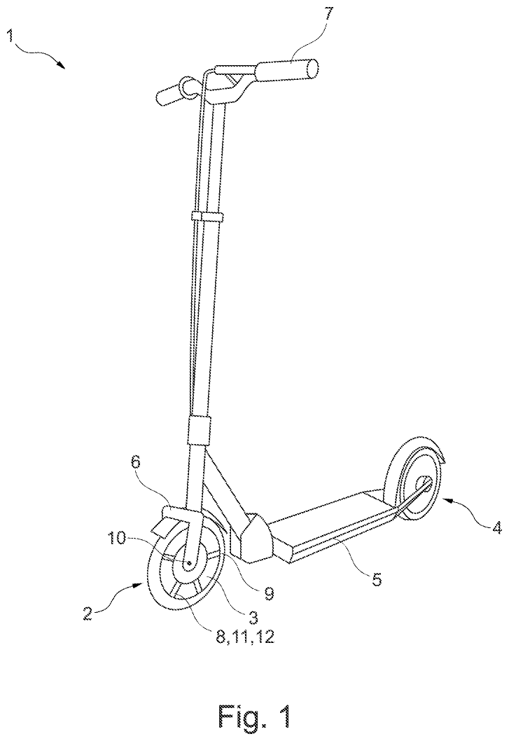

FIG. 1 shows a three-dimensional representation of a vehicle 1, wherein the vehicle 1 is designed as an electric motorcycle, electric pedal scooter or electric scooter, also known as an e-scooter. For this purpose, the vehicle 1 has a wheel module 2 with a wheel 3, which forms a front wheel of the vehicle 1. The wheel module 2 is used in particular to electrically drive the vehicle 1. In addition, the vehicle 1 has a rear wheel 4, in particular a non-powered rear wheel, which is rotatably mounted on a vehicle frame 5 of the vehicle 1.

The vehicle 1 has a wheel fork 6, wherein the wheel module 2 is rotatably mounted in the wheel fork 6. The wheel fork 6 is pivotally connected to the frame 5 via handlebars 7, so that the wheel module 2 can be pivoted via the handlebars 7 to steer the vehicle 1.

The wheel 3 of the wheel module 2 has a wheel rim 8 and a tire 9, the tire 9 being arranged on the wheel rim 8. For example, the wheel rim 8 is designed as a steel, aluminum or plastic rim. For example, the tire 9 is designed as a rubber tire filled with air.

The wheel module 3 has a wheel axle 10 which defines a main axis H with its longitudinal axis. The wheel 3 is arranged with its axis of rotation coaxially to the wheel axle 10. The wheel axle 10 is fixed to the wheel fork 6, wherein the wheel rim 8 is rotatably mounted on the wheel axle 10 via two bearing devices, e.g., rolling bearings.

To drive the wheel 3, the wheel module 2 has a drive device 11, for example an electric motor, integrated into the wheel rim 8. The drive device 11 has a stator which is connected to the wheel axle 10 in a non-rotatable manner and is arranged between the two bearing devices in the axial direction with respect to the main axis H. In addition, the drive device 12 has a rotor that is connected to the wheel rim 8 in a non-rotatable manner. In driving operation of the vehicle 1, the wheel rim 8 is driven by the drive device 11, with the wheel 3 rotating about the main axis H.

The wheel module 2 has a braking device 12, which is used to transmit a braking torque to the wheel 3. The braking device 12 is designed as a friction brake and is arranged on one side of the wheel rim 8 and/or is operatively connected to the wheel rim 8.

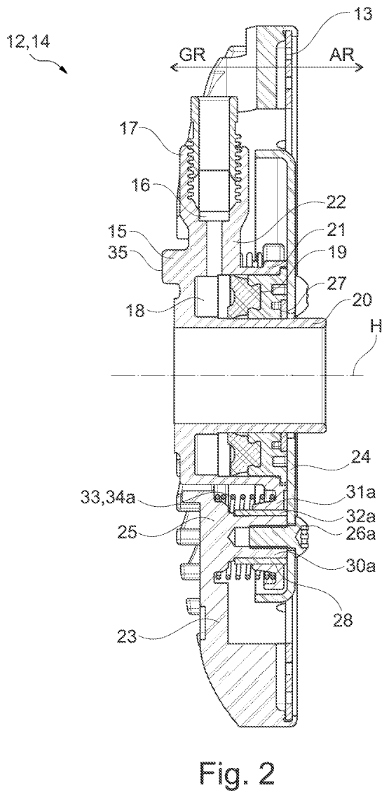

The braking device 12 has an annular brake pad, in particular extending around the main axis H, as one braking partner and a brake disc 13 (FIG. 2) as a further braking partner, wherein the brake pad and the brake disc 13 are arranged coaxially to one another with respect to the main axis H. The brake pad is non-rotatable with respect to the main axis H on an axial end face of the wheel rim 8, so that the brake pad is carried along by the wheel rim 8 during driving operation and rotates about the main axis H. The brake disc 13 is movable in an axial direction AR towards the brake pad and in an axial opposite direction GR away from the brake pad. In the direction of rotation about the main axis H, the brake disc 13 is coupled to the wheel axis 10 or the wheel fork 6 in a non-rotatable manner.

In an actuated state of the braking device 12, the brake disc 13 contacts the brake pad so that a frictional connection is formed to brake the rotating wheel 3 by friction between the brake disc 13 and the brake pad.

FIG. 2 shows a schematic longitudinal section through a brake unit 14, wherein the brake unit 14 forms the fork-fixed part of the braking device 12, in particular the brake unit 14 carries the brake disc 13 and displaces it in axial direction AR and opposite direction GR.

The brake unit 14 has a housing 15, wherein the housing 15 is arranged coaxially to the main axis H and is arranged on the wheel fork 6 in a non-rotatable manner. The brake unit 14 has a hydraulic unit 16, wherein the hydraulic unit 16 is arranged, in particular integrated, in the housing 15.

The hydraulic unit 16 has a connection 17 through which hydraulic pressure can be applied to it. The connection 17 is fluidically connected to an annular space 18 as a pressure chamber, wherein the annular space 18 forms a cylinder of the hydraulic unit 16. The annular space 18 is arranged coaxially with the main axis H. An annular piston 19 is arranged in the annular space 18, wherein the annular piston 19 as a cylinder in the annular space 18 can be displaced hydraulically in the axial direction AR. The annular piston 19 is configured in two parts in the axial direction. The housing 15 has a receiving section 20 for receiving the wheel axle 10, wherein the receiving section 20 forms an inner wall of the annular space 18. Further, the housing 15 has an outer wall 21, wherein the outer wall 21 delimits the annular space 18 radially on the outside. The receiving section 20 and the outer wall 21 are formed as an integrated housing base body 22.

The brake unit 14 has a braking element unit 23, wherein the braking element unit 23 carries the brake disc 13 and is displaced together with the latter in the axial direction AR or in the axial opposite direction GR by the hydraulic unit 16. The braking element unit 23 has a force distribution plate 24, wherein this is designed as a pot with a collar for stability reasons. In a radially inner region, the force distribution plate 24 rests on the annular piston 19 so that the force distribution plate 24 is carried along during an axial movement of the annular piston 19. The braking element unit 23 has a brake base body 25, wherein the braking element body 25 supports the brake disc 13. The brake base body 25 is connected to the force distribution plate 24 via a first, a second and a third screw connection 26 a, b, c, so that during axial movement the brake base body 25 and thus the brake disc 13 are carried along in the axial direction AR.

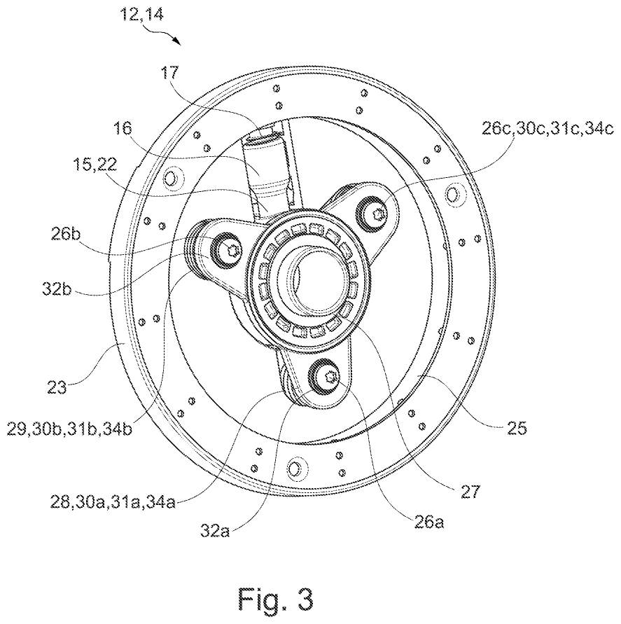

FIG. 3 shows an axial plan view of the brake unit 14 in a three-dimensional representation. However, the force distribution plate 24 is omitted in the representation here so that the underlying components can be seen. Firstly, the annular piston 19 can be seen once again, wherein the annular piston 19 is protected against penetrating contamination by a seal 27. Secondly, the screw connections 26 a, b, c can be seen, which are each offset from one another by 120°.

For guiding the brake base body 25 with the force distribution plate 24 and the annular piston 19 in the transverse direction to the axial direction AR, the brake unit 14 has a master guide 28 and an auxiliary guide 29. The master guide 28 and the auxiliary guide 29 are arranged coaxially to the screw connections 26 a, b and/or also offset by 120°. There is no guide under the third screw connection 26 c, but only a fixation between the force distribution plate 24 and the brake base body 25.

From a functional point of view, the radial clearance of the master guide 28 is smaller than that of the auxiliary guide 29. This design is supposed to help avoid over-definition. It is ensured in this way that the brake base body 25 and thus the brake disc 13 can be moved without jamming. A further technical effect of the master guide 28 or auxiliary guide 29 is that torques introduced during the braking process can be conducted about the main axis H from the brake disc 13 via the brake base body 25 to the housing 15. The radial clearance can optionally be measured locally with rotational symmetry on the respective guides 28 or 29; alternatively, the radial clearance is measured in the direction of rotation around the main axis H.

FIG. 2 shows a sectional view of the master guide 28, with the auxiliary guide 29 having an identical design. The master guide 28 has a first axle section 30 a, the axle section 30 a being integrally formed from the brake base body 25. A thread is provided on the radially inner side, in which a screw engages to form the screw connection 26 a. The auxiliary guide 29 has a second axle section 30 b, and the third screw connection 26 c has a third axle section 30 c, wherein the second and third axle sections 30 b, c have the same structure as the first axle section 30 a, so that reference is made to the description thereof.

The master guide 28 has a first guide section 31 a, wherein the first guide section 31 a receives the first axle section 30 a. In particular, the first guide section 31 a is arranged coaxially and concentrically to the first axle section 30 a. The auxiliary guide 29 has a second guide section 31 b, and the third screw connection 26 c has a third guide section 31 c, wherein the second and third guide sections 31 b, c have the same structure as the first guide section 31 a, so that reference is made to the description thereof.

The master guide 28 has a first guide sleeve 32 a, wherein the first guide sleeve 32 a is fitted to the first axle section 30 a and provides a guide surface for the first guide section 31 a. The auxiliary guide 29 has a second guide sleeve 32 b, which is fitted onto the second axle section 30 b and provides a second guide surface for the second guide section 31 a. The third screw connection 26 c does not have a guide sleeve so that the radial clearance can optionally be described as very large, in particular larger than the first and second radial clearances, or the third screw connection 26 c does not implement any guide function.

In this way, the torques introduced about the main axis H from the brake disc 13 due to the braking process are subsequently introduced into the housing 15 via the brake base body 25 via the master guide 28 and the auxiliary guide 29. The housing 15 has a form-fit section 35 which engages in the wheel fork 6 so that the torque can be diverted into the wheel fork 6.

The brake unit 14 has a return unit 33, the return unit 33 being formed by three return springs 34 a, b, c. FIG. 2 shows the first return spring 34 a, which is designed as a compression spring arranged coaxially with the master guide 18 and/or with the first axle section 30 a and is compressed during an axial movement of the brake disc 13 in the axial direction AR. The second and third return springs 34 b, c are arranged coaxially with the auxiliary guide 29 and coaxially with the second axle section 30 b and coaxially with the third axle section 30 c, respectively, and are also compressed during axial movement of the brake disc 13 in the axial direction AR.

As soon as the hydraulic pressure in the hydraulic unit 16 decreases, the brake disc 13 can be returned in the axial opposite direction GR by the spring force of the return springs 34 a, b, c.

### LIST OF REFERENCE NUMBERS

1 Vehicle
2 Wheel module
3 Wheel
4 Rear wheel
5 Vehicle frame
6 Wheel fork
7 Handlebars
8 Wheel rim
9 Tires
10 Wheel axle
11 Drive device
12 Braking device
13 Brake disc
14 Brake unit
15 Housing
16 Hydraulic unit
17 Connection
18 Annular space
19 Annular piston
20 Receiving section
21 Outer wall
22 Housing base body
23 Braking element unit
24 Force distribution plate
25 Brake base body
26a, b, c Screw connections
27 Seal
28 Master guide
29 Auxiliary guide
30 a, b, c Axle sections
31 a, b, c Guide section
32 a, b Guide sleeve
33 Return means
34a,b,c Return springs
35 Form-fit section

1. A brake unit for a vehicle, comprising:
a housing,
a hydraulic unit,
a braking element unit, wherein the braking element unit forms or supports a braking partner in a braking device for the vehicle, wherein the housing, the hydraulic unit or the braking element unit define a main axis,
wherein the hydraulic unit moves the braking element unit in an axial direction relative to the housing, in order to generate a braking force,
a guide unit, wherein the guide unit guides the braking element unit in a radial direction during an axial movement,
wherein the guide unit has a master guide and an auxiliary guide, wherein the master guide and the auxiliary guide are arranged eccentrically.

2. The brake unit according to claim 1, wherein the braking element unit has a braking surface, wherein the braking surface is formed circumferentially to the main axis or wherein the hydraulic unit has an annular space and an annular piston, wherein the annular space and the annular piston are formed circumferentially to the main axis.

3. The brake unit according to claim 1, wherein the master guide has a first radial clearance and the auxiliary guide has a second radial clearance, wherein the first radial clearance is smaller than the second radial clearance.

4. The brake unit according to claim 1, wherein the master guide has a first axle section, wherein the first axle section is arranged on the braking element unit, and a first guide section, wherein the first guide section is arranged on the housing, wherein the first axle section is coaxially arranged in the first guide section, or wherein the auxiliary guide has a second axle section, wherein the second axle section is arranged on the braking element unit, and a second guide section, wherein the second guide section is arranged on the housing, wherein the second axle section is coaxially arranged in the second guide section.

5. The brake unit according to claim 4, wherein the master guide has a first guide sleeve, wherein the first guide sleeve is placed on the first axle section, or the auxiliary guide has a second guide sleeve, and wherein the second guide sleeve is placed on the second axle section.

6. The brake unit according to claim 4, wherein the housing has a housing base body, wherein the first and second guide sections are integrally formed by the housing base body, or the braking element unit has a brake base body, wherein the first and second axle sections are integrally formed by the brake base body.

7. The brake unit according to claim 4, wherein the braking element unit has a force distribution plate, wherein the force distribution plate is operatively connected to the hydraulic unit, and wherein the force distribution plate is connected via the first, second and third axle sections to direct braking force from the hydraulic unit into the braking element unit.

8. The brake unit according to claim 7, wherein a return unit for returning the braking element unit in an axial opposite direction, wherein the return unit has a first return spring, a second return spring and a third return spring, wherein the first return spring is arranged coaxially with the master guide or the first axle section, the second return spring is arranged coaxially with the auxiliary guide or the second axle section, and the third return spring is arranged coaxially with the third axle section.

9. A braking device, wherein a braking element unit according to claim 1, wherein the braking element unit has a brake disc, wherein the brake disc is made of metal, or wherein the braking device has a brake pad, wherein the brake pad is connectable to a wheel of the vehicle in a non-rotatable manner.

10. A vehicle having the brake unit according to claim 1, wherein the vehicle is designed as an electric motorcycle or as an electric scooter.
